(19) United States
(12) Patent Application Publication
(10) Pub. No.: US 2010/0026808 A1
(43) Pub. Date: Feb. 4, 2010

(54) Surveillance System for Terminals

(75) Inventors: Tatsuhiko KAGEHIRO, Kokubunji (JP); Masanori Miyoshi, Mito (JP); Takashi Watanabe, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Ltd.

(21) Appl. No.: 12/103,249

(22) Filed: Apr. 15, 2008

(30) Foreign Application Priority Data
Apr. 19, 2007 (JP) 2007-110609

(51) Int. Cl. H04N 7/18

(52) U.S. Cl. 348/152; 348/E07.085

(57) ABSTRACT

A surveillance system for terminals for controlling generation of false or wrong information by displaying an inquiry message to a user. The surveillance system includes a terminal having an individual information acquirement unit acquiring private information on a user and also having an operation guide information display unit displaying an operational guide to prompt the user to enter an input; a monitor camera taking the terminal; an abnormality detection device for detecting a suspicious behavior of the user based on a video of the user; and a display control unit causing the operation guide information display unit of the terminal to display inquiry information to the user when the abnormality detection device detects a suspicious behavior of the user. The abnormality detection device selects subsequent processing operations according to input information of the user to the inquiry information.

### BACKGROUND OF THE INVENTION

The present invention relates to surveillance systems for terminals and more particularly, to a surveillance system for terminals which can monitor an illegal operation for a terminal.

For a terminal apparatus, in particular, such an apparatus as an ATM (automated teller machine) terminal easily susceptible to an illegal action as a target, a monitor camera or various types of sensors are mounted on the apparatus to surveille the illegal action. However, manual surveillance of the apparatus based on signals from many monitor camera and/or sensors involves highly costly. For this reason, it is expected to automatically surveille the apparatus based on application of image processing or signal processing techniques.

For example, JP-A-7-49915 discloses a system which includes an image monitoring means for monitoring an ATM (automated teller machine) and its vicinity based on images and a plurality of abnormality generation factors detecting means provided by a number corresponding to the number of abnormality generation factors for the ATM and its vicinity for detecting the abnormality generation factors, and which is arranged so that, when at least one of the abnormality generation factor detecting means detects one of the abnormality generation factors, an image monitored by the image monitoring means is recorded and a warning is issued.

Also disclosed in JP-A-6-162316 is a system, when a customer or user inserts such a medium as a debit card in an automated teller machine and later forgets to get back it or when the user forgets to get back her or his belonging placed on the control panel of the machine, which detects the fact and informs the user of the presence of her or his belonging.

JP-A-2005-346514 discloses a system, when a monitor camera detects the placement of a suspicious object, which issues a warning.

### SUMMARY OF THE INVENTION

In such a surveillance system as to monitor a terminal, when image information or from a monitor camera or a sensor signal is input to the system to automatically detect an abnormality in the terminal, it is difficult for the system to automatically detect the abnormality without any error. Further, when a result of the abnormality detection is false information, the system cannot control the subsequent processing procedure. In addition, it is also difficult for the system to cope with user's complex terminal operations.

When the system detects a suspicious object or an abnormal behavior in such an environment as to undergo many external perturbations, for example, using an image recognition technique not completed yet; the system may, in some cases, generate false information (wrong or erroneous information). Or the system involves a failure in the camera or sensor or noise generation with a reduced detection accuracy.

Since the erroneous detection of the surveillance system results in an increased man power cost and a degraded customer service, it is required to increase an accuracy and to take a measure against generation of false information. As a method of detecting an abnormal behavior, there is known such a technique that abnormal operations or behaviors are previously learned so that a behavior departed from the learned result is discriminated and determined as an abnormality. However, user's operations to the terminal have features unique or peculiar to the user individual based on her or his peculiar ways or on routine works. For this reason, when the normal behaviors of all users are previously learned as a single feature for user discrimination, the system may issue wrong information to specific user or users.

In view of these problems in the prior art, it is therefore an object of the present invention to provide a terminal surveillance technique which can suppress generation of false information.

In accordance with an aspect of the present invention, the above problems are solved by providing a system which follows.

A surveillance system for terminals in accordance with the aspect includes a terminal having an individual information acquirement unit for acquiring private information on a user and also having an operation guide information display unit for displaying an operational guide to prompt the user to enter an input; a monitor camera for photographing or taking the terminal and its vicinity; an abnormality detection device for detecting a suspicious behavior of the user on the basis of a video of the user photographed or taken by the monitor camera; and a display control unit for causing the operation guide information display unit of the terminal to display inquiry information to the user when the abnormality detection device detects a suspicious behavior of the user. The abnormality detection device selects subsequent processing operations according to input information of the user to the inquiry information.

Since the present invention has such an arrangement as mentioned above, there can be provided a terminal surveillance technique which can suppress generation of false information.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for explaining the operation of an ATM surveillance system for surveilling an ATM;

FIG. 2 is a diagram for explaining an arrangement of the ATM surveillance system;

FIG. 3 shows an example of message outputs to a user;

FIG. 4 is a diagram for explaining cooperative operations between user's behavior analysis and detection of a suspicious object;

FIG. 5 is a diagram for explaining details of operations of a process of suspicious object detection based on an image on the casing of the ATM; and

FIG. 6 is a diagram for explaining details of operations of a process of suspicious behavior detection.

### DETAILED DESCRIPTION OF THE INVENTION

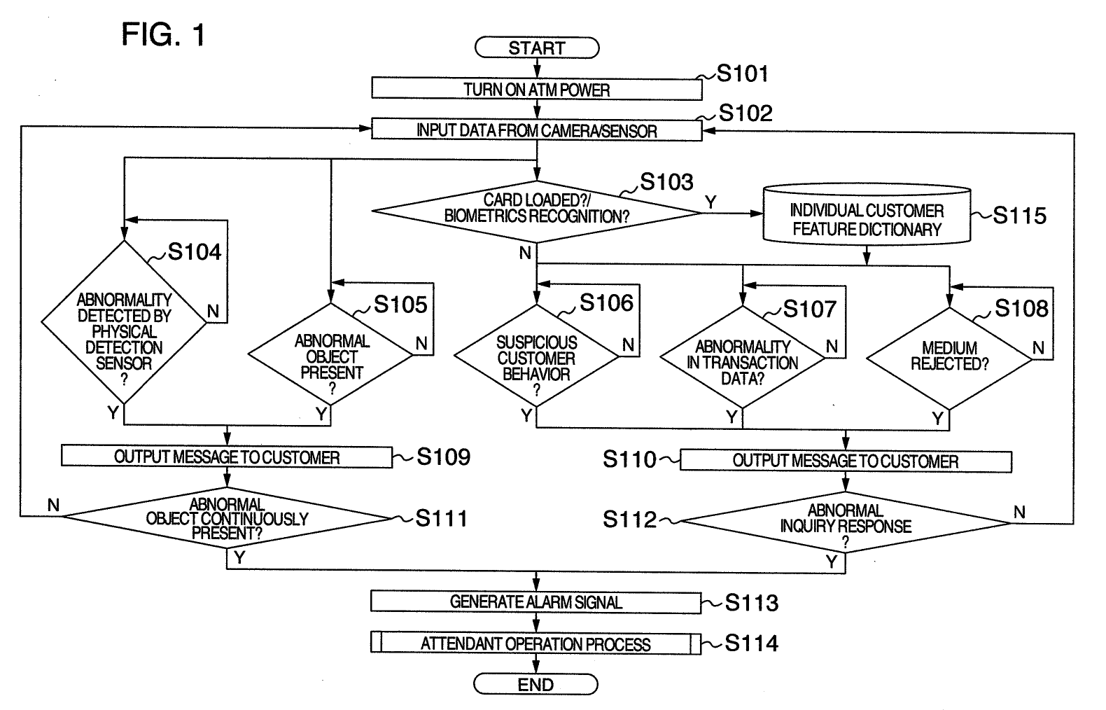

Explanation will be made as to an embodiment of the present invention by referring to the attached drawings. It is assumed herein that an ATM (automated teller machine) is used as a terminal. FIG. 1 is a diagram for explaining the operation of an ATM surveillance system for surveilling the ATM. When the power of the ATM is first turned ON (step S101), the system acquires information about the conditions of the casing of the ATM or about customer's operations (step S102), and the system detects various types of abnormalities on the basis of the acquired information.

The system first detects whether or not an object is placed or installed on the basis of a physical sensor installed on the ATM terminal (step S104). When detecting the presence of the object placed on the ATM casing, the system informs the user (customer) of the fact by displaying a message on the display (step S109). The system also detects whether or not a suspicious object is present based on an image of a monitor camera. When detecting the presence of the suspicious object, the system displays a message on the display (step S109). When the user fails to respond to the message and the system continuously detects the suspicious object (step S111), the system issues a warning (step S113).

The system also determines whether or not the user inserted a card (debit card) in the ATM or whether or not the user was authenticated based on biometrics recognition (step S103). When finding the successful authentication, the system extracts features (normal features) in the normal condition of the authenticated customer by referring to an individual customer feature dictionary (step S115).

The system then compares the extracted normal features with user's (customer's) features acquired from the monitor camera or the sensor to determined whether or not there is an abnormality (abnormal behavior, abnormal transaction, etc.) in the acquired user's features. The abnormality determination is carried out by the system which detects an abnormal behavior based on an image input from the monitor camera (step S106), by the system which detects an abnormal transaction different from a normal transaction by referring to a transaction record (step S107), or by the system which detects an abnormal frequency of paper money rejection based on the discrimination of the loaded paper money medium from a genuine money medium (step S108).

Such abnormality detection can be carried out even when the system fails to authenticate the user. In this case, however, in place of features (normal features) of the customer in her or his normal condition, normal feature estimated from a feature distribution of many customers are used.

When detecting an abnormality in any of the steps S106, S107, and S108, the system outputs a message to the user. The message can be displayed, for example, by displaying the message on an operation guide information display unit of the ATM operated by the user (step S110). The system determines whether or not a user's response to the message is normal (step S112). When determining that the response is abnormal, the system sets off an alarm (step S113). After an ATM attendant confirms the alarm, he takes a measure against the alarm, for example, by stopping the operation of the terminal (step S114). When determining no abnormality in the steps S111 and S112, the system returns to the step S102.

In the present embodiment, in this way, when detecting an abnormality in the steps S104, S105, S106, S107, and S108, the system does not inform the user of the abnormality merely as a warning but presents it in the form of information different for different users (customers). In other words, the system does not inform the user of the abnormality in the form of a mere warning but displays the abnormality in the form of an inquiry message of soft expression. And the system changes the subsequent processing operations according to a user's response to the message.

The soft inquiry is, for example, “What can we do for you?”, “Would you like us to call an attendant?”, or “Please be sure nothing behind you”. For these inquiries, if the user gives a normal response (if the user wants to call an attendant or the user asks the attendant about how to operate”), the abnormality detection device can determine that the warning of the abnormality detection device was false. When the abnormality detection device cannot determine whether the warning is false, the device changes (increases) a detection sensitivity and further repeats the abnormality detecting operation.

When the system can already identify the customer based on the entered password, the card authentication, the biometrics recognition, and so on; the system discriminates her or his behavior features by referring to the features of the customer stored in the aforementioned individual customer feature dictionary. During the normal operations of customers, the individual customer feature dictionary can be enhanced by observing and sequentially learning the customers' normal operations.

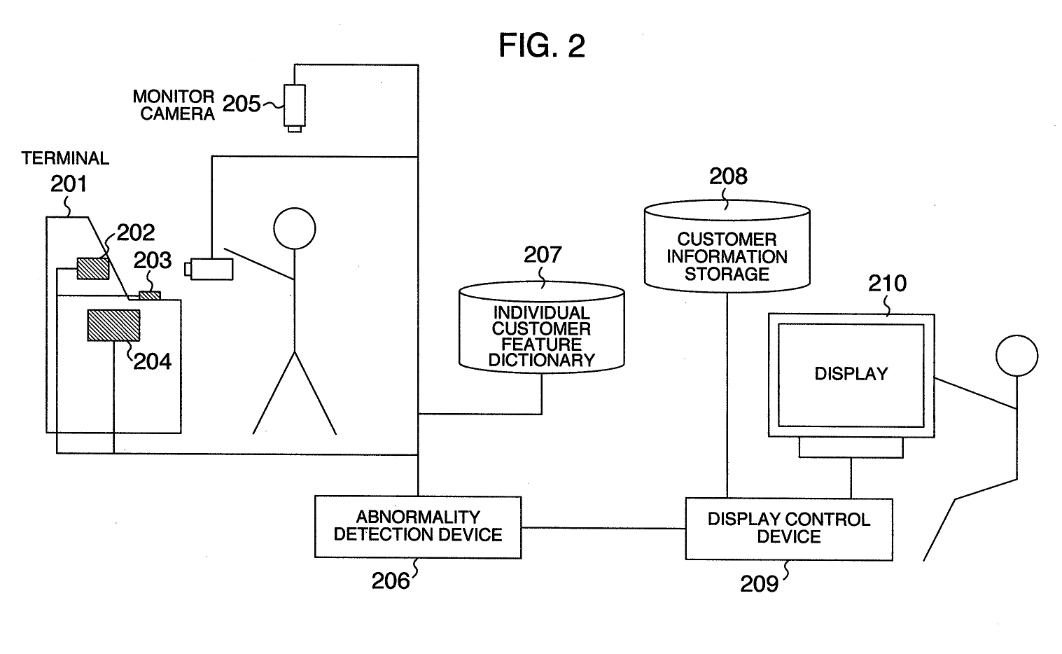

FIG. 2 is a diagram for explaining an arrangement of the ATM surveillance system. In FIG. 2, reference numeral 201 denotes an ATM as a terminal, and numeral 205 denotes a monitor camera for surveilling the ATM by photographing or picking up the image of the upper part of the casing of the ATM, user's hand actions, and the entire action of the user. The ATM 201 includes a genuine/counterfeit discriminating device 204 for discriminating the loaded paper money from a counterfeit money. The ATM also includes a card reader 202 which outputs private information obtained from the loaded card. The ATM further includes a biometrics recognition device 203 which outputs private information obtained from user's living body.

The image and paper money information thus obtained is transmitted to an abnormality detection device 206. The abnormality detection device 206 compares the received information with normal features stored in an individual customer feature dictionary 115 to detect an abnormal behavior and an abnormal frequency of money paper rejection.

The private information obtained from the card reader 202 and the biometrics recognition device 203 is input to the abnormality detection device 206 to be used as information for the reference of the individual customer feature dictionary 115. A detection result as an output of the abnormality detection device 206 is input to a display control device 209. The display control device 209, which is connected to a video output monitor 210, displays a warning indicative of an abnormality or a video from the monitor camera on the monitor 210 when the system detects the abnormality.

An attendant monitoring the monitor 210 determines the subsequent operation of the ATM 201 by referring to the displayed warning and video. The display control device 209 is also connected with a storage 208, which in turn records the video photographed by the monitor camera and the abnormality detection warning.

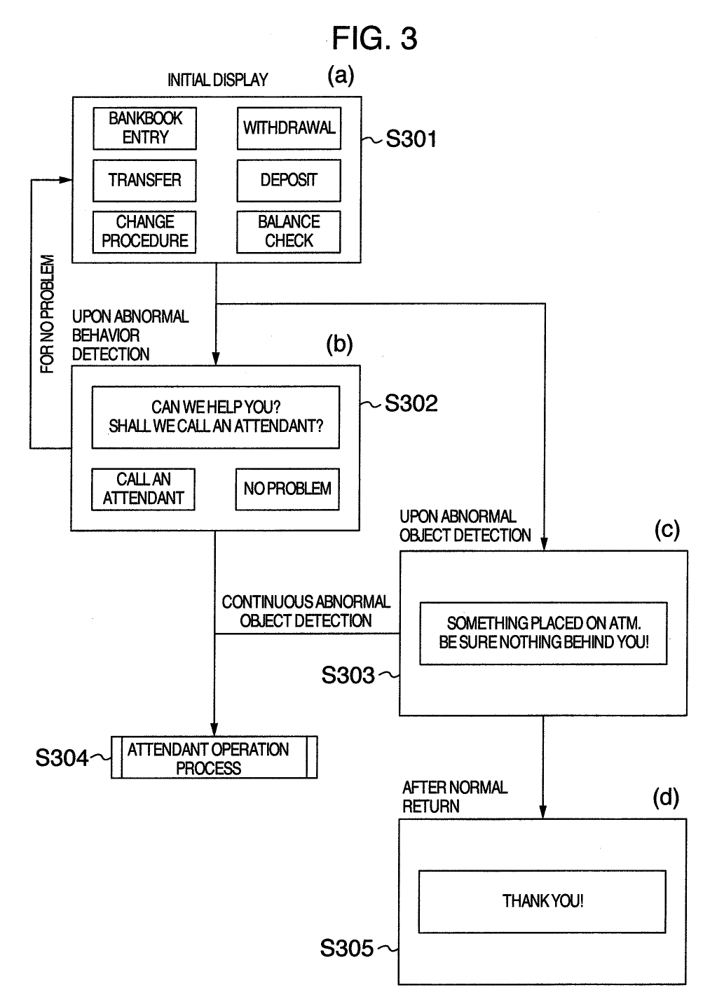

FIG. 3 shows an example of message outputs to a user. In an initial state of the ATM 201, an initial screen (a) appears on the operation guide information display unit of the ATM to get ready for a user's operation input (step S301). When the user starts the operation of the ATM and the system detects an user's abnormal behavior or an abnormal transaction, the system displays an abnormal behavior detection screen (b) to get ready for user's response (step S302). When the user responds to it as “no problem”, the system returns to the operation of the ATM in a normal state. When the user responds to it as “call an attendant”, the attendant conducts a necessary operation in a step S304.

Even when the user responds to it as “no problem” as mentioned above, however, it is not guaranteed that the user is acting in good faith. To avoid this, it is desirable to change (increase) the detection sensitivity to repeat the abnormality detection. When the system detects a suspicious object on the ATM casing, the system displays an abnormality object detection screen (c) and continue to detect the suspicious object (step S303). Thereafter, when the system fails to detect the suspicious object within a predetermined time, the system displays a normal return screen (d) and terminates its operation. When the system still detects the suspicious object even after passage of the predetermined time, the system informs the attendant to prompt the attendant to conduct the necessary operation.

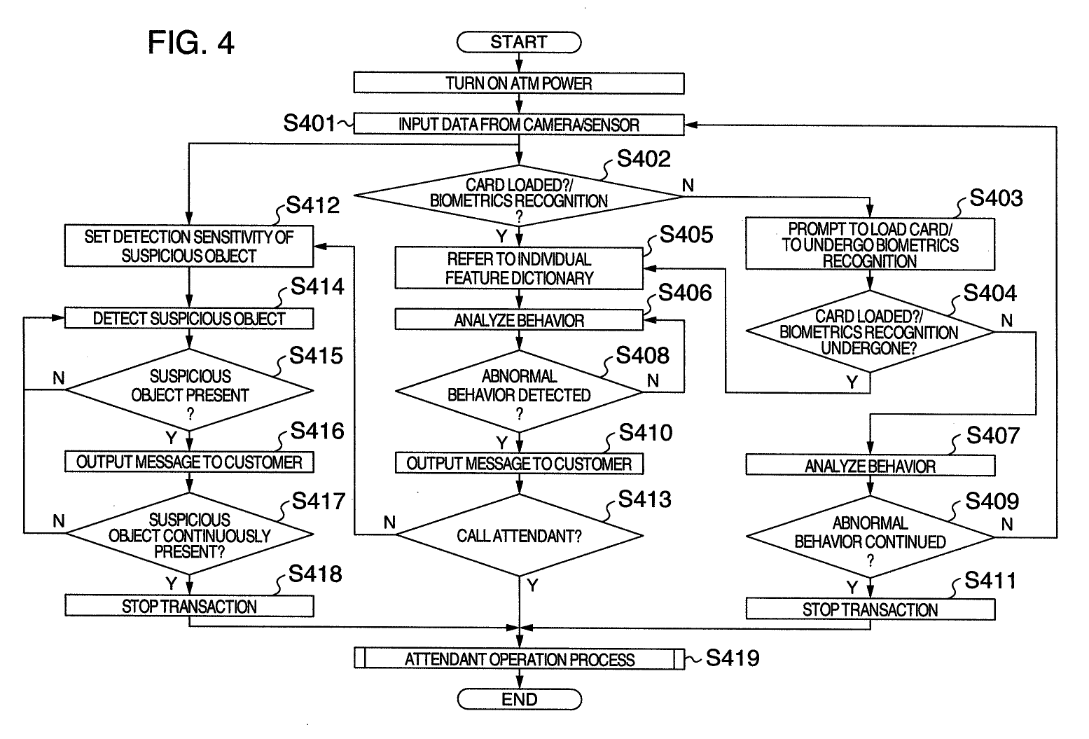

FIG. 4 is a diagram for explaining cooperative operations between user's behavior analysis and detection of a suspicious object. After the power of the ATM is turned ON, the system collects information about the condition of the ATM terminal casing and customer's operating condition from the monitor camera and the sensor (step S401). The collected information is used for the detection of a suspicious object and for the behavior analysis.

Explanation will be made first as to the behavior analysis. The system determines whether or not the user can be identified based on a transaction card loaded by the user or on user's biometrics recognition (step S402). When the system can identify the user, the system extracts normal features of the user with use of user identification information by referring to the individual customer feature dictionary (step S405). When failing to identify the user, the system prompts the user to again load the card or to undergo the biometrics recognition (step S403). And the system determines whether or not the user can be identified based on the transaction card loaded by the user or on the user's biometrics recognition. When determining that the user can be identified, the system proceeds to the step S405. Otherwise, the system proceeds to a step S407 (step S404).

When failing to determine that the user cannot be identified in the step S404, the system analyzes user's behavior with use of a standard feature dictionary (step S407), and measures an abnormal-behavior sustained time(step S409). When failing to detect any abnormal behavior, the system returns to the step S401. When the abnormal behavior continues for a time beyond a predetermined time (or when the system detects the abnormal behavior, the system stops the transaction, and informs the attendant of the fact to ask him to conduct the subsequent operation (steps S411 and S419).

When determining in the step S402 or S404 that the user can be identified, the system extracts user's normal features by referring to the individual customer feature dictionary (step S405). The system then analyzes user's behavior based on the extracted features. When detecting an abnormality, the system outputs a message (abnormal behavior detection screen) to the user (steps S406, S408, and S410).

At this time, when the user responds to the output message and instructs “call an attendant”, the system performs attendant operation process (steps S413 and S419). When user's response is other than “call an attendant”, the system increases the sensitivity of a suspicious object detection process (step S412). When the system executes the suspicious object detection process with the increased sensitivity and finds a suspicious object, the system outputs a message (abnormal object detection screen) to the user (steps S414, S415, and S416). Even after this, the system continuously executes the suspicious object detection process. When continuously detecting the suspicious object for a time beyond a predetermined time, the system stops the transaction and informs the attendant of the fact to ask the attendant to conduct the subsequent operation (steps S417, S418, and S419).

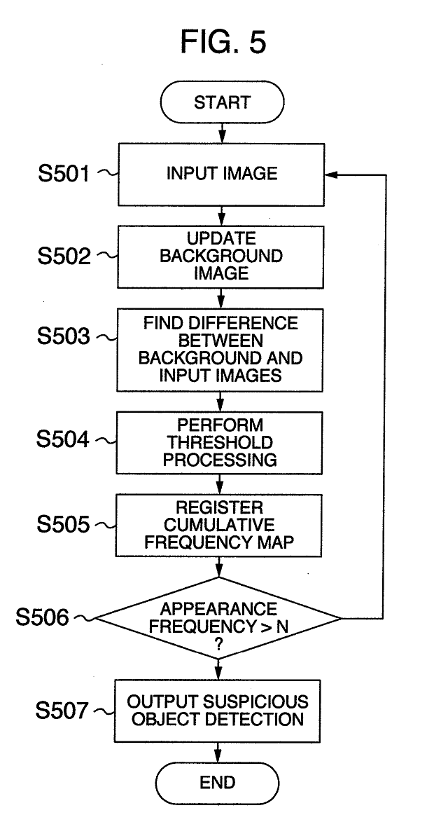

FIG. 5 is a diagram for explaining details of the suspicious object detection process based on an image taken from the upper side of the ATM casing with use of the monitor camera.

The system first inputs an image photographed by the monitor camera 205 (step S501), generates and updates an optimum background image on the basis of variation or frequency information on the input image in a time axis (step S502). The system generates an image as a difference between the updated background image and the input image (step S503), performs threshold processing on the differential image for binarization, and extracts an object (abnormal object) placed on the ATM casing (step S504).

The system next plots the extracted object on a cumulative frequency map separately prepared and measures a continuous appearance time (steps S505 and S506). In the cumulative frequency map, it is assumed that a cumulative value for an area where the system fails to observe the suspicious object is set at “0”. Thus only an object continuously observed is measured on the cumulative frequency map. When an appearance frequency on the map is greater than a threshold (step S506), the system determines that the suspicious object is placed on the ATM casing for a time beyond the predetermined time and outputs a detection result (step S507).

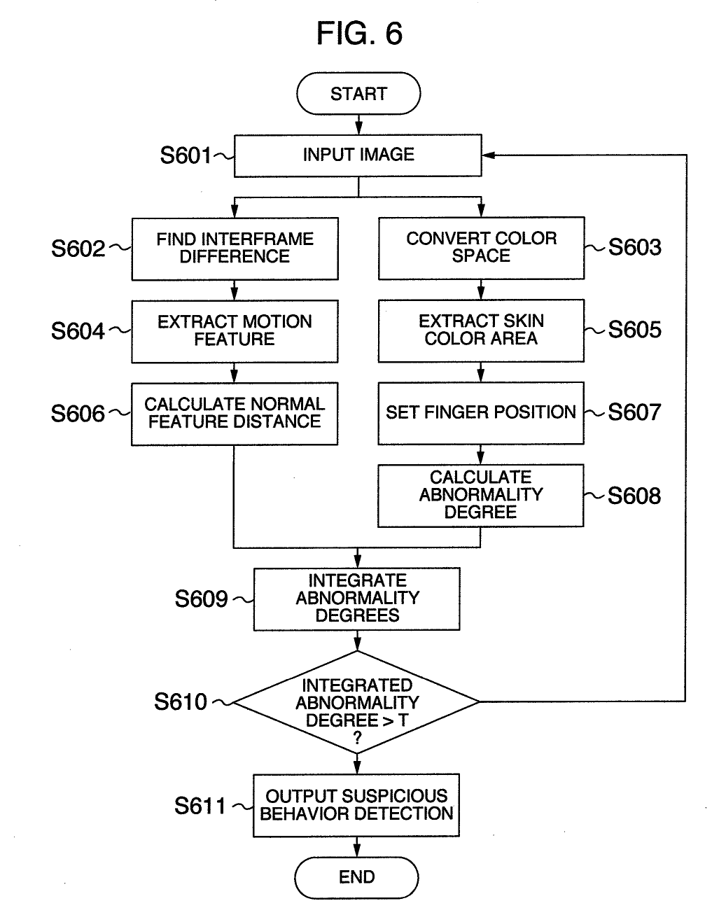

FIG. 6 is a diagram for explaining details of a suspicious behavior detection process based on user's image obtained from the monitor camera.

In this example, the system inputs user's image photographed by the monitor camera 205 (step S601), performs abnormal behavior detecting operation on the basis of a motion feature in the input image (steps S602 to S606), or performs the abnormal behavior detecting operation on the basis of information about user's finger tips in the input image (steps S603 to S608).

For the abnormal behavior detecting operation based on the motion feature, the system first generates an image as a difference between different frames (step S602), extracts user's motion components, and generates a motion feature (step S604). As the motion feature generating method, an optical flow, CHLAC, and so on are well known. The system compares the motion feature generated by photographing the user with a normal feature generated by previously photographing the user's normal operation and calculates a distance in a feature space (step S606).

For the abnormal behavior detecting operation based on the finger tip positional information, the system first performs color space conversion from a RGB space to an HSV space, and extracts a user's skin color area on the basis of a saturation image obtained by the color space conversion (steps S603 and S605). This is because the ATM casing has a chromatic color in many cases and it is easy to extract such an area (hand) having a high saturation as a skin color.

The system extracts a finger position from the extracted skin color area (step S607). In the imaging environment, the position of the monitor camera is fixed and a positional relationship between the user and the ATM terminal is fixed. For this reason, the direction of the monitor camera when user's hand is in the image is restricted. Thus when the system performs raster scanning operation from a specific direction in the image, a position when the scan is overlapped first with the skin color area becomes a finger position. The system calculates a degree of abnormality (abnormality degree) in the finger position on the basis of the thus-extracted finger position and a frequency distribution of finger positions previously learned so far from normal operation images (step S608).

Next, the system integrates a distance in the feature space calculated from the motion feature and the abnormality degree calculated based on the finger position information to calculate an integrated abnormality degree (step S609). The system then compares the calculated integrated abnormality degree with a threshold. When the integrated abnormality degree is larger than the threshold, the system determines that the behavior of the user is suspicious and outputs a result of suspicious behavior detection.

As has been explained above, in accordance with the present embodiment, even when the abnormality detection device detects an abnormality, the device displays an inquiry message on the operation guide information display unit prior to issuance of a detection output as a warning, and changes the subsequent processing operation according to user's response to the message. As a result, the monitor detection device can be suppressed from issuing a false warning. Further, the suppression of the false warning generation enables reduction of a labor cost because an attendant or attendants are required for the warning generation.

Since the detection sensitivity can be variably controlled depending upon the way of user's response to the inquiry, a frequency of erroneous warning (wrong or false warning) in suspicious cases can be reduced. Further, since the warning of the abnormality detection device is presented to the user in the form of an inquiry, the system can avoid a bad psychological effect on the customer upon generation of a false warning.

When the user can be identified, the system can acquire a behavior habit or a transaction procedure peculiar to the user by searching the individual customer feature dictionary, compare the acquired information with a feature of the user in observation, and accurately determine an abnormality in the behavior or the like. In other words, even when an abnormal behavior is applied to one user, the abnormal behavior may not be applied to another user and be taken as a normal behavior. Thus by identifying a normal behavior feature for each user, the system can increase a detection accuracy for abnormality detection.

When transaction data of a user who conducts only a specific transaction (such as withdrawal) is registered in the individual customer feature dictionary and when the user conducts unusual operation different from his usual operation, the system can cope with it, for example, by changing the detection sensitivity. In this way, the system can strictly check non-routine operation.

It should be further understood by those skilled in the art that although the foregoing description has been made on embodiments of the invention, the invention is not limited thereto and various changes and modifications may be made without departing from the spirit of the invention and the scope of the appended claims.

1. A surveillance system for terminals comprising:
a terminal including an individual information acquirement unit for acquiring private information on a user and an operation guide information display unit for displaying an operational guide to prompt the user to enter an input;
a monitor camera for taking the terminal and its vicinity;
an abnormality detection device for detecting a suspicious behavior of the user on the basis of a video of the user taken by the monitor camera; and
a display control unit for causing the operation guide information display unit of the terminal to display inquiry information to the user when the abnormality detection device detects a suspicious behavior of the user,
wherein the abnormality detection device selects subsequent processing operations according to input information of the user to the inquiry information.

2. The surveillance system for terminals according to claim 1, wherein the abnormality detection device detects a suspicious behavior of the user on the basis of information on a finger position of the user.

3. The surveillance system for terminals according to claim 1, wherein the abnormality detection device increases a detection sensitivity for subsequent detecting operation when receiving an input response of the user saying “no abnormality” to the inquiry.

4. The surveillance system for terminals according to claim 1, further comprising an individual customer feature dictionary having feature information on users stored therein, wherein the abnormality detection device searches the individual customer feature dictionary on the basis of the private information acquired by the individual information acquirement unit, and determines the suspicious behavior of the user on the basis of searched feature information.

5. The surveillance system for terminals according to claim 4, wherein information stored in the individual customer feature dictionary is updated based on input information when the terminal is used.

6. A surveillance system for terminals comprising:
a terminal including an individual information acquirement unit for acquiring private information on a user and an operation guide information display unit for displaying an operational guide to prompt the user to enter an input;
a monitor camera for taking the terminal and its vicinity;
an abnormality detection device for detecting a suspicious object placed on the terminal on the basis of a video of the terminal taken by the monitor camera and detecting a suspicious behavior of the user on the basis of a video of the user; and
a display control unit for causing the operation guide information display unit of the terminal to display inquiry information to the user when the abnormality detection device detects the suspicious object or the suspicious behavior, wherein the abnormality detection device selects subsequent processing operations according to input information of the user to the inquiry information.

7. A method of surveilling a terminal including an individual information acquirement unit for acquiring private information on a user and an operation guide information display unit for displaying an operational guide to prompt the user to enter an input with use of a monitor camera for monitoring the terminal and its vicinity, comprising the steps of:
detecting a suspicious object placed on the terminal on the basis of a video of the terminal taken by the monitor camera and monitoring a suspicious behavior of the user on the basis of a video of the user;
displaying inquiry information to the user on the operation guide information display unit of the terminal when the abnormality detection device detects the suspicious object or the suspicious behavior; and
selecting subsequent processing operations according to input information of the user to the inquiry information.

8. The method of surveilling a terminal according to claim 7, wherein the suspicious behavior of the user is detected on the basis of information on a finger position of the user.

9. The method of surveilling a terminal according to claim 7, wherein a detection sensitivity for subsequent processing operations is changed according to an input response of the user to the inquiry information.
